(19) United States
(12) Patent Application Publication
(10) Pub. No.: US 2013/0070890 A1
(43) Pub. Date: Mar. 21, 2013

(54) GROOVED NUCLEAR FUEL ASSEMBLY COMPONENT INSERT

(71) Applicants: Hua Jiang, Lexington, SC (US); James A. Sparrow, Irmo, SC (US)

(72) Inventors: Hua Jiang, Lexington, SC (US); James A. Sparrow, Irmo, SC (US)

(73) Assignee: WESTINGHOUSE ELECTRIC COMPANY LLC, CRANBERRY TOWNSHIP, PA (US)

(21) Appl. No.: 13/235,541

(22) Filed: Sep. 19, 2011

(51) Int. Cl. G21C 3/04

(52) U.S. Cl. 376/455

(57) ABSTRACT

A nuclear fuel assembly component such as a control rod that has a cylindrical insert such as neutron absorbing material that is closely received within a cladding that is sealed at either end with end caps. The cylindrical member has grooves formed in its side wall extending from an upper surface to a lower surface to permit air to escape from the cladding as the cylindrical member is loaded into the cladding during manufacture.

### BACKGROUND

1. Field

This invention pertains generally to a nuclear reactor fuel assembly and, more particularly, to a grooved insert that fits within the cladding of one or more components of a nuclear fuel assembly.

2. Description of Related Art

The primary side of nuclear reactor power generating systems which are cooled with water under pressure comprises a closed circuit which is isolated and in heat exchange relationship with a secondary circuit for the production of useful energy. The primary side comprises the reactor vessel enclosing a core internal structure that supports a plurality of fuel assemblies containing fissile material, the primary circuit within heat exchange steam generators, the inner volume of a pressurizer, pumps and pipes for circulating pressurized water; the pipes connecting each of the steam generators and pumps to the reactor vessel independently. Each of the parts of the primary side comprising a steam generator, a pump, and a system of pipes which are connected to the vessel form a loop of the primary side.

For the purpose of illustration, FIG. 1 shows a simplified nuclear reactor primary system, including a generally cylindrical pressure vessel 10 having a closure head 12, enclosing a nuclear core 14. A liquid reactor coolant, such as water, is pumped into the vessel 10 by pump 16 through the core 14 where heat energy is absorbed and is discharged to a heat exchanger 18, typically referred to as the steam generator, in which heat is transferred to a utilization circuit (not shown), such as a steam-driven turbine generator. The reactor coolant is then returned to the pumps 16, completing the primary loop. Typically, a plurality of the above-described loops are connected to a single reactor vessel 10 by reactor coolant piping 20.

An exemplary reactor design is shown in more detail in FIG. 2. In addition to the core 14, comprised of a plurality of parallel, vertical, co-extending fuel assemblies 22, for the purpose of this description, the other vessel internal structures can be divided into lower internals 24 and upper internals 26. In conventional designs, the lower internals' function is to support, align and guide core components and instrumentation as well as direct flow within the vessel. The upper internals restrain or provide a secondary restraint for the fuel assemblies 22 (only two of which are shown for simplicity in FIG. 2), and support and guide instrumentation and components, such as control rods 28. In the exemplary reactor shown in FIG. 2, coolant enters the reactor vessel 10 through one or more inlet nozzles 30, flows down through an annulus between the vessel and the core barrel 32, is turned 180° in a lower plenum 34, passes upwardly through a lower support plate 37 and a lower core plate 36 upon which the fuel assemblies are seated and through and about the assemblies. In some designs, the lower support plate 37 and the lower core plate 36 are replaced by a single structure, a lower core support plate having the same elevation as 37. The coolant flow through the core and surrounding area 38 is typically large on the order of 400,000 gallons per minute at a velocity of approximately 20 feet per second. The resulting pressure drop and frictional forces tend to cause the fuel assemblies to rise, which movement is restrained by the upper internals, including a circular upper core plate 40. Coolant exiting the core 14 flows along the underside of the upper core plate 40 and upwardly through a plurality of perforations 42. The coolant then flows upwardly and radially outward to one or more outlet nozzles 44.

The upper internals 26 can be supported from the vessel or the vessel head and include an upper support assembly 46. Loads are transmitted between the upper support assembly 46 and the upper core plate 40, primarily by a plurality of support columns 48. Support columns are respectively aligned above selected fuel assemblies 22 and perforations 42 in the upper core plate 40.

Rectilinearly moveable control rods 28, which typically include a drive shaft 50 and spider 52 of neutron poison rods, are guided through the upper internals 26 and into aligned fuel assemblies 22 by control rod guide tubes 54. The guide tubes are fixedly joined through the upper support assembly 46 and the top of the upper core plate 40. The support column 48 arrangement assists in retarding guide tube deformation under accident conditions which could detrimentally effect control rod insertion capability.

FIG. 3 is an elevational view, represented in vertically shortened form, of a fuel assembly being generally designated by reference character 22. The fuel assembly 22 is the type used in a pressurized water reactor and has a structural skeleton, which at its lower end includes a bottom nozzle 58. The bottom nozzle 58 supports the fuel assembly 22 on the lower core plate 36 in the core region of the nuclear reactor. In addition to the bottom nozzle 58, the structural skeleton of the fuel assembly 22 also includes a top nozzle 62 at its upper end and a number of guide tubes or thimbles 84 which align with the guide tubes 54 in the upper internals. The guide tubes or thimbles 84 extend longitudinally between the bottom and top nozzles 58 and 62 and at opposite ends are rigidly attached thereto.

The fuel assembly 22 further includes a plurality of transverse grids 64 axially spaced along and mounted to the guide thimbles 84 and an organized array of elongated fuel rods 66 transversely spaced and supported by the grids 64. The grids 64 are conventionally formed from an array of orthogonal straps that are interleaved in an egg-crate pattern with the adjacent interface of four straps defining approximately square support cells through which the fuel rods 66 are supported in transverse, spaced relationship with each other. In many designs, springs and dimples are stamped into the opposite walls of the straps that form the support cells. The springs and dimples extend radially into the support cells and capture fuel rods 66 therebetween exerting pressure on the fuel rod cladding to hold the rods in position. The orthogonal array of straps is welded at each strap end to a border strap to complete the grid structure 64. Also, the assembly 22, as shown in FIG. 3, has an instrumentation tube 68, located in the center thereof that extends between and is captured by the bottom and top nozzles 58 and 62. With such an arrangement of parts, fuel assembly 22 forms an integral unit capable of being conveniently handled without damaging the assembly of parts.

As mentioned above, the fuel rods 66 in the array thereof in the assembly 22 are held in spaced relationship with one another by the grid 64 spaced along the fuel assembly length. Each fuel rod 66 includes a plurality of nuclear fuel pellets 70 and is closed at its opposite ends by upper and lower end plugs 72 and 74. The pellets 70 are maintained in a stack by a plenum spring 76 disposed between the upper end plug 72 and the top of the pellet stack. The fuel pellets 70, composed of fissile material are responsible for creating the reactive power of the reactor. The cladding which surrounds the pellets functions as a barrier to prevent the fission by-products from entering the coolant and further contaminating the reactor system.

To control the fission process, a number of control rods 78 are reciprocally moveable in the guide thimbles 84 located at predetermined positions in the fuel assembly 22. Specifically, a rod cluster control mechanism 80 positioned above the top nozzle 62, supports a plurality of the control rods 78. The control mechanism has an internally threaded cylindrical hub member 82 with a plurality of radially extending flukes or arms 52 that form the spider previously noted with regard to FIG. 2. Each arm 52 is interconnected to a control rod 78 such that the control rod mechanism 80 is operable to move the control rods vertically in the guide thimbles 84 to thereby control the fission process in the nuclear fuel assembly 22, under the motive power of a control rod drive shaft 50 which is coupled to the control hub 80, all in a well known manner. 10011] The control rods 78 like the fuel rods 66 are constructed from a tubular cladding that is sealed by an upper and lower end plug. A neutron absorbing material such as Ag—In—Cd (silver indium cadmium) occupies the lower portion of the interior of the cladding and is generally provided in the form of a bar or solid cylindrical insert. Normally, only a 0.00075 inch (0.00191 cm) clearance is allowed between the outside diameter of the silver rod and the inside diameter of the cladding. Recently, difficulties have been experienced in manufacturing the control rods in loading the silver into the cladding as well as replacing the air inside of the rods with gases that improve the heat transfer between the absorber and the cladding which threatens production schedules and raises manufacturing costs. The difficulties experienced have been due to trapped air behind the bar of silver which propels the bar back out of the cladding as there is not enough clearance for the air to escape. The tight clearance also adversely affects the ability to remove the air which remains in the rod after the silver has been loaded so that the air can be replaced with a gas that provides better heat transfer during operation. Narrowing the silver rod outside diameter is not a practical option since this would reduce the absorber rod worth which would degrade the margin for safe shutdown in commercial nuclear reactors which is unacceptable.

Accordingly, a new control rod design is desired that will reduce manufacturing time and improve efficiency of rod plenum gas exchange without meaningfully reducing the absorber rod worth.

### SUMMARY

These and other objects are achieved by a nuclear fuel assembly component having an elongated, hollow tubular cladding enclosed at a bottom of the cladding by a lower end cap and enclosed at an upper end of the cladding by an upper end cap. At least one substantially cylindrical member, including an activation component, is closely received within at least a portion of the hollow interior of the tubular cladding. The cylindrical member has a top surface and a bottom surface and a substantially round sidewall extending between the top surface and the bottom surface. The sidewall includes at least one groove that extends between the top surface and the bottom surface.

In one embodiment, the groove extends in a helix from the top surface to the bottom surface. In a second embodiment, the groove is substantially straight between the top surface and the bottom surface, extending substantially parallel to the axis of the elongated cladding. Preferably, the groove includes a plurality of grooves that respectively extend from the top surface to the bottom surface and are equidistantly spaced circumferentially around the sidewall. Desirably, the number of grooves in the plurality of grooves is an odd number, preferably three, five or seven.

In still another embodiment, the groove has a substantially semi-circular cross-section. Alternately, the groove may have a U-shaped cross-section, preferably, with rounded corners. Desirably, the cross-sectional area of the groove is generally between 0.0002 and 0.0060 sq. in. and more preferably between 0.0004 and 0.0020 sq. in. Overall, the lateral projected area of the groove at any axial cross section should not exceed 0.15 percent of the cross-sectional area of the cylindrical member. Preferably, the cross-sectional area of the groove is not substantially larger than 0.108 percent of the cross-sections of the cylindrical member.

In one embodiment, the nuclear fuel assembly component may be a control rod wherein the substantially cylindrical member is a neutron absorbing active ingredient such as Ag—In—Cd. Alternately, the fuel assembly component may be a nuclear fuel rod wherein the active ingredients are isotopes of uranium, and the cylindrical member is a fuel pellet.

The embodiments described herein also contemplate a nuclear fuel assembly having such a component as well as a nuclear reactor system employing such fuel assemblies.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a nuclear reactor system to which the embodiments described herein can be applied;

FIG. 2 is an elevational view, partially in section of a nuclear reactor vessel and internal components to which the embodiments set forth herein can be applied;

FIG. 3 is an elevational view, partially in section of a fuel assembly illustrated in vertically shortened form, with parts broken away for clarity;

FIG. 4 is a plan view of a prior art silver indium cadmium cylindrical bar that is the active ingredient within the cladding of a control rod;

FIG. 5 is a perspective view of the cylindrical member illustrated in FIG. 4;

FIG. 6 is a plan view of one embodiment described herein for the cylindrical member that has five grooves along its sidewall between the upper surface and lower surface;

FIG. 7 is a perspective view of the cylindrical member shown in FIG. 6;

FIG. 8 is a plan view of the silver indium cadmium bar that incorporates seven grooves along its sidewall in accordance with another embodiment described herein;

FIG. 9 is a perspective view of the cylindrical member shown in FIG. 8;

FIG. 10 is a plan view, similar to FIGS. 6 and 8, which shows three circumferentially spaced grooves extending along the side wall; and

FIG. 11 is a perspective view of a nuclear fuel pellet that incorporates the embodiment of grooves illustrated in FIG. 9, for a control rod cylindrical insert.

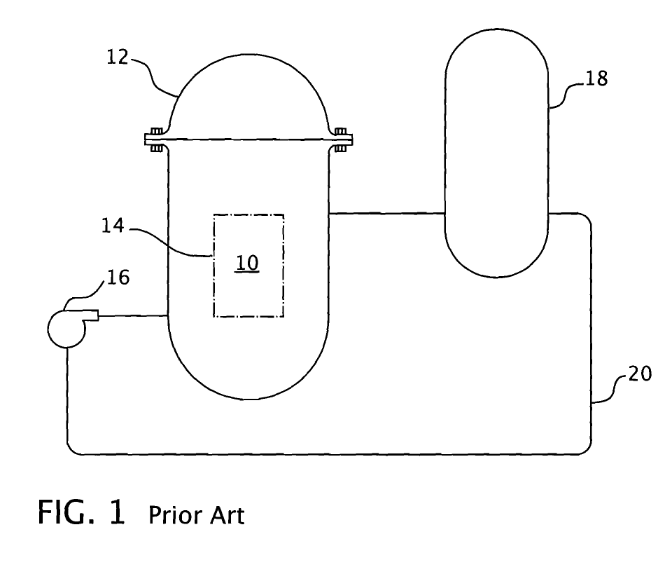

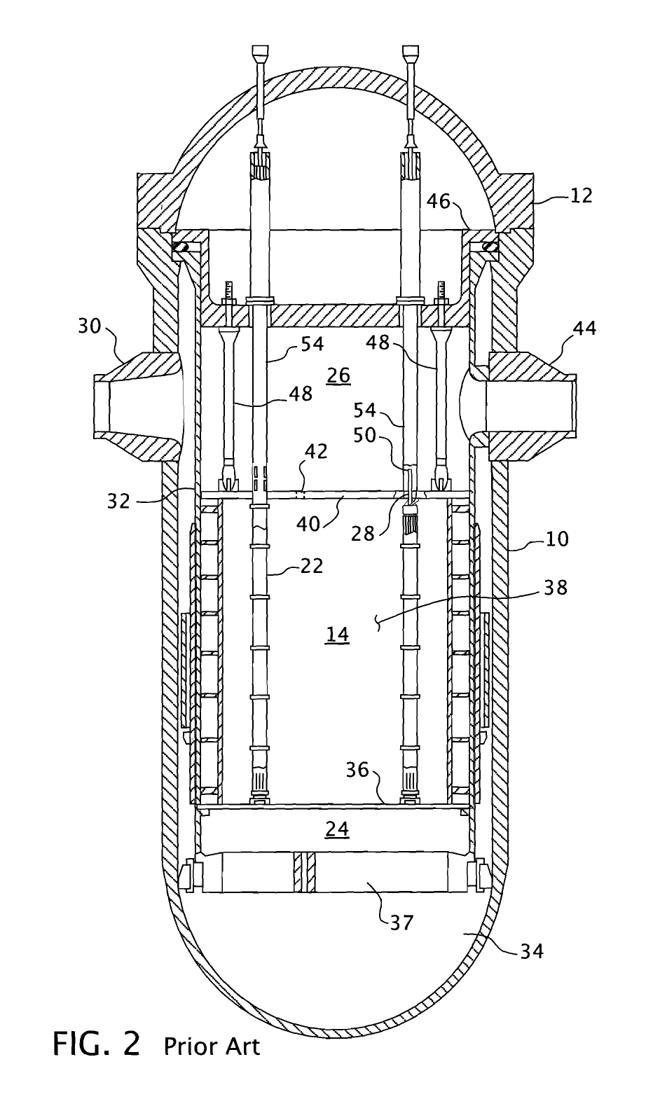

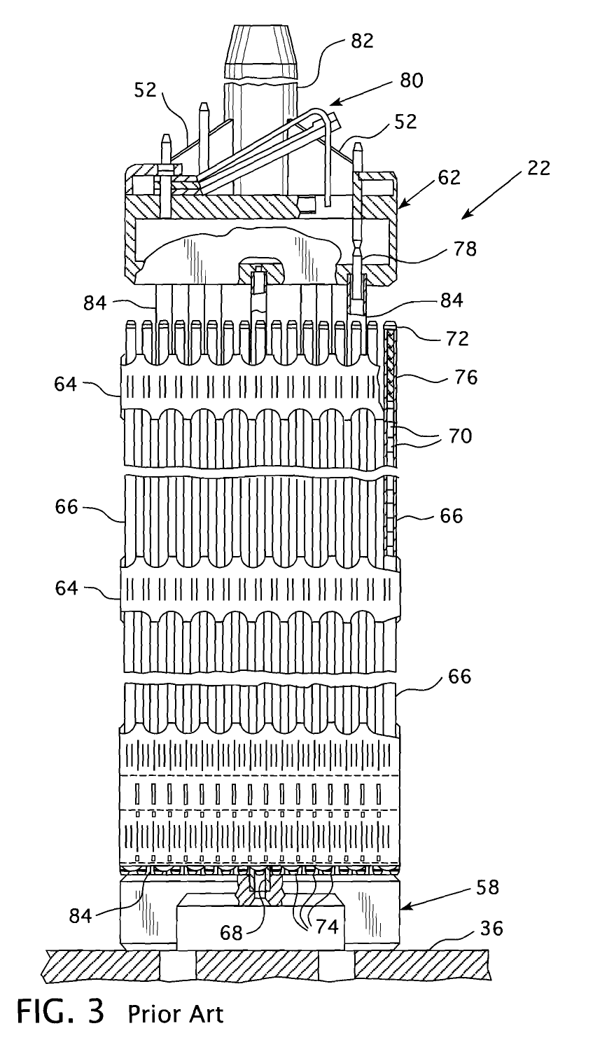

### DESCRIPTION OF THE PREFERRED EMBODIMENT

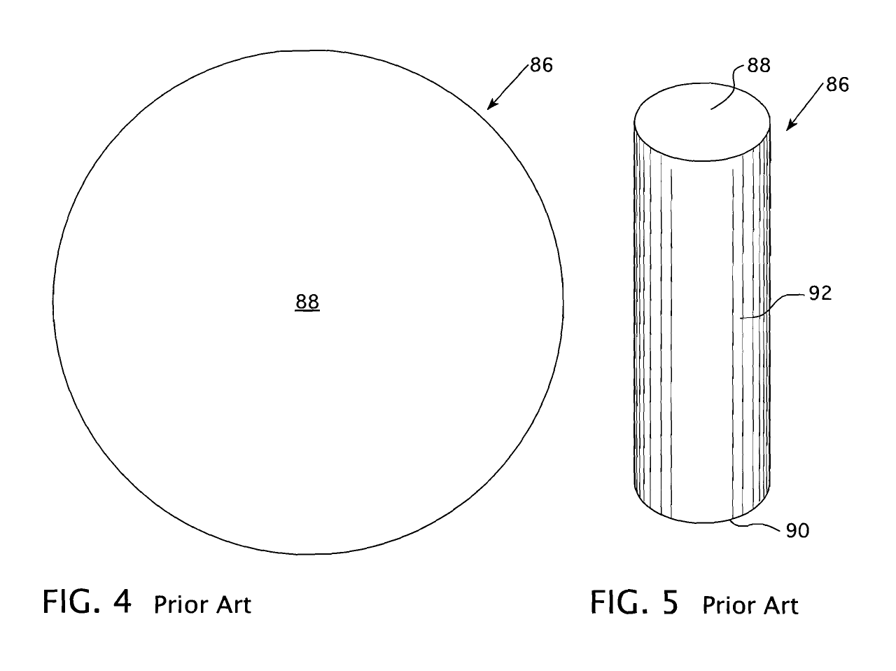

Currently, control rods for pressurized water reactors are typically formed from a cylindrical tubular cladding, commonly constructed from stainless steel, with upper and lower end plugs sealing the ends of the tubular cladding. A neutron absorbing cylindrical member such as silver indium cadmium or pure silver in the form of a cylindrical member is situated within the hollow interior of the cladding, normally extending from the lower end cap to an elevation below the upper end cap. The cylindrical member, containing the active neutron absorbing ingredient as currently formed, is illustrated in the plan view shown in FIG. 4 and the perspective view illustrated in FIG. 5. Presently, a fuel assembly manufacturing facility has experienced manufacturing difficulties in loading the active neutron absorbing cylindrical member into the rod cluster control assemblies, which threatens the facility's ability to meet its production schedules and delivery targets. Manufacturing difficulties add to the manufacturing time which translates into cost. The problem is a column of air that is trapped behind the cylindrical bar of neutron absorbing material as it is loaded into the cladding which propels the bar back out of the tube, as there is not enough clearance for the air to escape. The clearance between the silver bars and the inside diameter of the cladding is in the order of 0.00075 inch (0.00191 cm). Reducing the outside diameter of the silver bars is out of the question since that would reduce the absorber rod worth which would degrade the margins for safe shutdown in a commercial nuclear reactor, which is unacceptable.

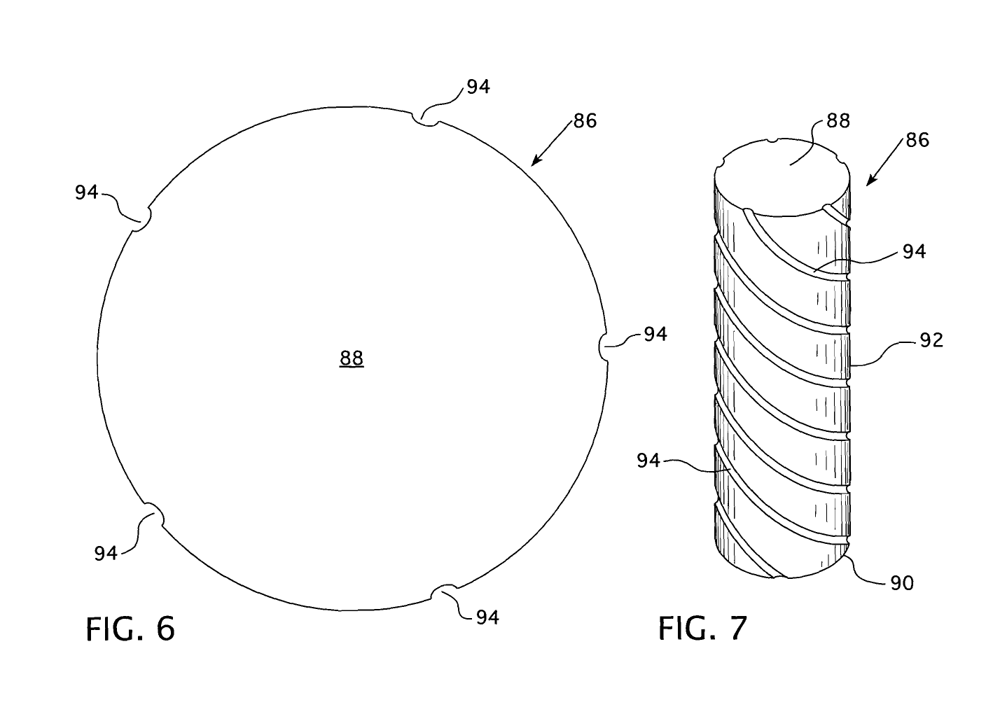

To overcome this difficulty, the embodiments described herein add an odd number of axially extending grooves to the sidewall of the neutron absorbing rods that are loaded into the hollow interior of the control rod cladding. The grooves extend from an upper surface of the neutron absorbing rod to a lower surface to provide air escape passages to overcome the manufacturing difficulties while maintaining almost 100 percent of the original rod worth, thus minimizing the effect on the margin of safe shutdown of a nuclear reactor. Preferably, three, five or seven grooves are employed and extend parallel to the axis of the rod or follow a helical path around the circumference of the side wall of the rod from the upper surface to the lower surface. FIG. 4 is a plan view of a prior art cylindrical rod insert 86 for control rod 78 showing a top surface 88 of a generally circular configuration. FIG. 5 is a perspective view of the cylindrical member shown in FIG. 4 showing the smooth side wall 92 that extends between the upper surface 88 and the lower surface 90. It can readily be appreciated that with close tolerances between the side wall 92 and the inside diameter of the control cladding there is no room for the air to escape as the cylindrical member 86 is loaded into the cladding. FIGS. 6 and 7 show one embodiment of the concepts claimed hereafter. FIG. 6 shows a plan view of the top surface 88 and FIG. 7 shows a perspective view, in which an axial groove is formed in the side wall 92 extending from the upper surface 88 to the lower surface 90. In this embodiment, the grooves have a U-shaped cross-section and five grooves are formed in the side wall equidistantly spaced around the circumference of the cylindrical member.

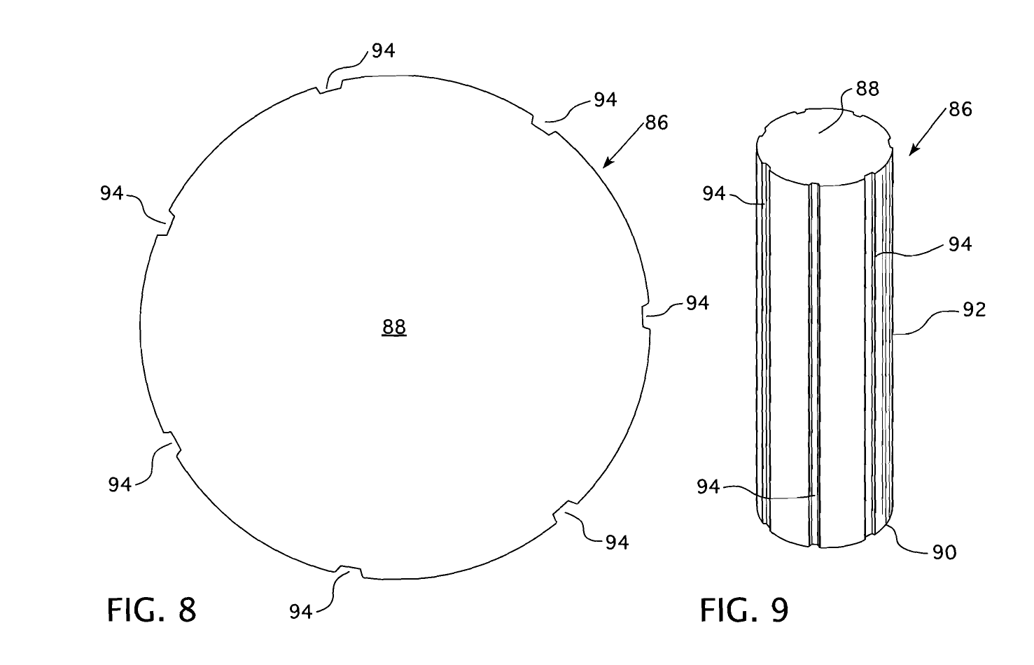

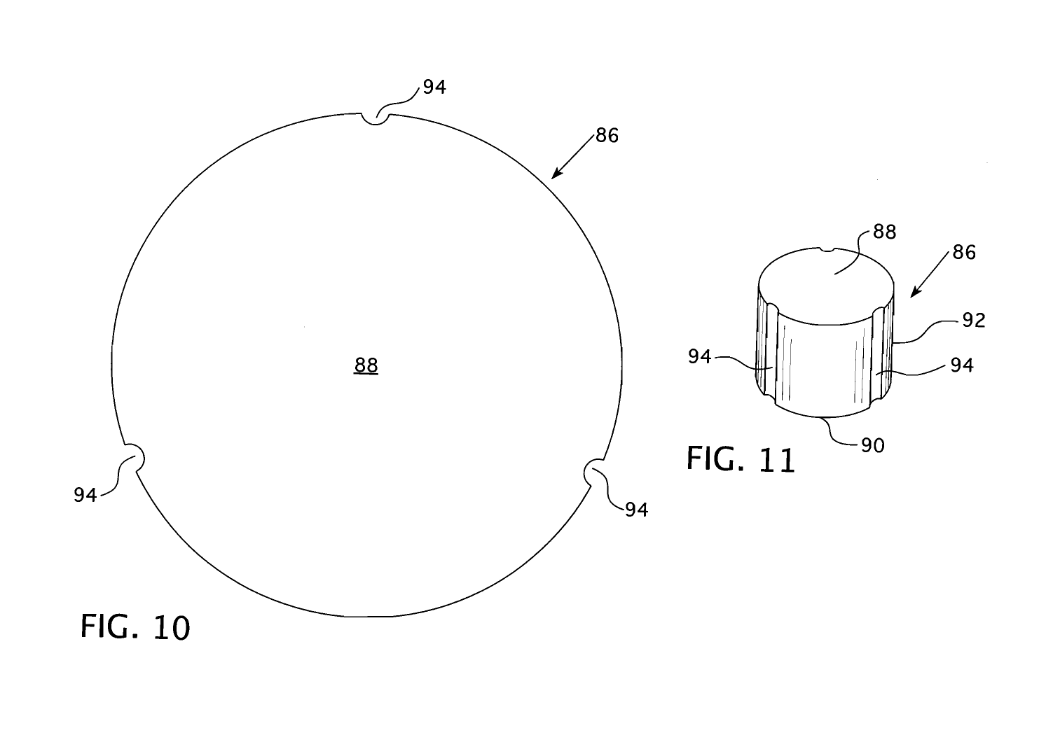

FIGS. 8 and 9, respectively, correspond to FIGS. 6 and 7 and show an embodiment that employs seven grooves equidistantly spaced around the circumference of the cylindrical member 86. Similarly, FIG. 10 shows a plan view of another embodiment that employs three circumferentially spaced grooves. However, the grooves shown in FIG. 10 have a circular cross-section. FIG. 11 shows an additional embodiment with the concept claimed herein applied to a fuel pellet employing two spaced helical grooves in the sidewall.

While the grooves displace some neutron absorbing material, the effective loss in cross-section of the grooved absorber, from a neutron perspective, would be approximately 0.0077 percent for five grooves and 0.0108 percent from seven grooves, which is quite insignificant from a nuclear reactor shutdown margin perspective, but would allow for a significant manufacturing improvement.

Accordingly, while specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all improvements thereof.

What is claimed is:

1. A nuclear fuel assembly component comprising:
an elongated, hollow tubular member having an axial dimension along an elongated length;
a lower end cap enclosing a bottom of the tubular member at a first end of the elongated length;
an upper end cap enclosing a top of the tubular member at a second end of the elongated length;
at least one substantially cylindrical member closely received within the hollow of the tubular member between the lower end cap and the upper end cap, the cylindrical member having a top surface and a bottom surface and a substantially round sidewall extending between the top surface and the bottom surface; and
a groove in the sidewall extending between the top surface and the bottom surface.

2. The nuclear fuel assembly component of claim 1 wherein the groove extends in a helix from the top surface to the bottom surface.

3. The nuclear fuel assembly component of claim 1 wherein the groove is substantially straight between the top surface and the bottom surface and substantially parallel to the axis.

4. The nuclear fuel assembly component of claim 1 including a plurality of grooves that respectively extend from the top surface to the bottom surface, circumferentially spaced around the sidewall.

5. The nuclear fuel assembly component of claim 4 wherein a number of grooves in the plurality of grooves is an odd number.

6. The nuclear fuel assembly component of claim 5 wherein the number is 3, 5 or 7.

7. The nuclear fuel assembly component of claim 1 wherein the groove has a substantially semicircular cross-section.

8. The nuclear fuel assembly component of claim 1 wherein the groove has a substantially “U”-shaped cross-section.

9. The nuclear fuel assembly component of claim 8 wherein the “U”-shaped cross-section has substantially rounded corners.

10. The nuclear fuel assembly component of claim 1 wherein the area of the cross-section of the groove is substantially between 0.0002 and 0.0060 sq. in.

11. The nuclear fuel assembly component of claim 1 wherein the area of the cross-section of the groove is substantially between 0.0004 and 0.0020 sq. in.

12. The nuclear fuel assembly component of claim 1 wherein the lateral projected area of the groove at any axial cross section should not exceed 0.15 percent of the cross-sectional area of the cylindrical member.

13. The nuclear fuel assembly component of claim 1 wherein the area of the cross-section of the groove is not substantially larger than 0.0108% of the cross-section of the cylindrical member.

14. The nuclear fuel assembly component of claim 1 wherein the nuclear fuel assembly component is a control rod.

15. The nuclear fuel assembly component of claim 10 wherein the substantially cylindrical member is formed from Ag—In—Cd.

16. The nuclear fuel assembly component of claim 1 wherein the nuclear fuel assembly component is a fuel rod.

17. The nuclear fuel assembly component of claim 16 wherein the substantially cylindrical member is a fuel pellet.

18. A nuclear fuel assembly having a component comprising:
an elongated, hollow tubular member having an axial dimension along an elongated length;
a lower end cap enclosing a bottom of the tubular member at a first end of the elongated length;
an upper end cap enclosing a top of the tubular member at a second end of the elongated length;
at least one substantially cylindrical member closely received within the hollow of the tubular member between the lower end cap and the upper end cap, the cylindrical member having a top surface and a bottom surface and a substantially round sidewall extending between the top surface and the bottom surface; and
a groove in the sidewall extending between the top surface and the bottom surface.

19. A nuclear reactor system having a fuel assembly with a component comprising:
an elongated, hollow tubular member having an axial dimension along an elongated length;
a lower end cap enclosing a bottom of the tubular member at a first end of the elongated length;
an upper end cap enclosing a top of the tubular member at a second end of the elongated length;
at least one substantially cylindrical member closely received within the hollow of the tubular member between the lower end cap and the upper end cap, the cylindrical member having a top surface and a bottom surface and a substantially round sidewall extending between the top surface and the bottom surface; and
a groove in the sidewall extending between the top surface and the bottom surface.
